(19) United States
(12) Patent Application Publication
(10) Pub. No.: US 2019/0098084 A1
(43) Pub. Date: Mar. 28, 2019

(54) Storage Medium Storing Control Program, Control Method, and Control Apparatus

(71) Applicant: Brother Kogyo Kabushiki Kaisha, Nagoya-shi (JP)

(72) Inventors: Kumi Hatada, Tokai-shi (JP); Yasuhiro Kudo, Ichinomiya-shi (JP)

(21) Appl. No.: 16/105,108

(22) Filed: Aug. 20, 2018

(30) Foreign Application Priority Data
Sep. 27, 2017 (JP) 2017-186742

(51) Int. Cl. H04L 29/08; H04L 12/26

(52) U.S. Cl. CPC H04L 67/1031; H04L 43/16; H04L 67/1029

(57) ABSTRACT

A storage medium stores a control program including: when there is a conference server having processing load larger than or equal to first threshold, determining possible combinations from a plurality of combinations of the plurality of processes that is allocated to a plurality of conference servers, the possible combinations being combinations in which the processing load of each conference server is smaller than or equal to second threshold; calculating evaluation information for evaluating the plurality of processes, the evaluation information being calculated for each possible combination based on at least one of the plurality of conference servers that executes the plurality of processes and the plurality of terminal apparatuses participating in the plurality of teleconferences controlled by the plurality of processes; determining, based on the evaluation information, one of the possible combinations as an execution combination that is a combination of the processes to be executed by each conference server.

### CROSS REFERENCE TO RELATED APPLICATIONS

This application claims priority from Japanese Patent Application No. 2017-186742 filed Sep. 27, 2017. The entire content of the priority application is incorporated herein by reference.

### TECHNICAL FIELD

This disclosure relates to a storage medium storing a control program, a control method, and a control apparatus for realizing a teleconference by performing communication through a network.

### BACKGROUND

A technique is disclosed for transferring a conference server to which a terminal apparatus connects a session to another conference server in a group conference system to which a conference server is applied. In this technique, the order of terminal apparatuses that change a destination of a session is determined based on simultaneous sessions of a terminal apparatus, a charging method, a speech time, an operating time, and so on. A conference server to be connected to a terminal apparatus transmits a call control request to a call control server so that the conference servers are transferred according to the determined order. The call control server transfers a destination conference server of a terminal apparatus to another conference server according to a call control request from the conference server.

### SUMMARY

According to one aspect, this specification discloses a non-transitory computer-readable storage medium storing a control program executable on a computer of a control apparatus configured to perform communication with a plurality of conference servers configured to execute a plurality of processes that controls respective ones of a plurality of teleconferences executed among a plurality of terminal apparatuses. The control program causes, when executed, the control apparatus to perform operations including: determining, based on first information indicative of a processing load of each of the plurality of conference servers, whether there is a conference server having the processing load larger than or equal to a first threshold among the plurality of conference servers; in response to determining that there is a conference server having the processing load larger than or equal to the first threshold, determining, based on the first information and second information, possible combinations from a plurality of combinations of the plurality of processes that is allocated to the plurality of conference servers, the second information being indicative of the processing load of each of the plurality of processes, the possible combinations being the plurality of combinations in which the processing load of each of the plurality of conference servers is smaller than or equal to a second threshold; calculating evaluation information for evaluating the plurality of processes corresponding to each of the possible combinations, the evaluation information being calculated for each of the possible combinations based on at least one of the plurality of conference servers that executes the plurality of processes and the plurality of terminal apparatuses participating in the plurality of teleconferences controlled by the plurality of processes; determining, based on the evaluation information, one of the possible combinations as an execution combination that is a combination of the plurality of processes to be executed by each of the plurality of conference servers; and transmitting a notification to the plurality of conference servers such that the plurality of processes is executed by the execution combination, thereby allocating the plurality of processes to the plurality of conference servers.

According to another aspect, this specification also discloses a control method of performing communication with a plurality of conference servers configured to execute a plurality of processes that controls respective ones of a plurality of teleconferences executed among a plurality of terminal apparatuses. The control method including: determining, based on first information indicative of a processing load of each of the plurality of conference servers, whether there is a conference server having the processing load larger than or equal to a first threshold among the plurality of conference servers; in response to determining that there is a conference server having the processing load larger than or equal to the first threshold, determining, based on the first information and second information, possible combinations from a plurality of combinations of the plurality of processes that is allocated to the plurality of conference servers, the second information being indicative of the processing load of each of the plurality of processes, the possible combinations being the plurality of combinations in which the processing load of each of the plurality of conference servers is smaller than or equal to a second threshold; calculating evaluation information for evaluating the plurality of processes corresponding to each of the possible combinations, the evaluation information being calculated for each of the possible combinations based on at least one of the plurality of conference servers that executes the plurality of processes and the plurality of terminal apparatuses participating in the plurality of teleconferences controlled by the plurality of processes; determining, based on the evaluation information, one of the possible combinations as an execution combination that is a combination of the plurality of processes to be executed by each of the plurality of conference servers; and transmitting a notification to the plurality of conference servers such that the plurality of processes is executed by the execution combination, thereby allocating the plurality of processes to the plurality of conference servers.

According to still another aspect, this specification also discloses a control apparatus. The control apparatus includes a communication interface, a controller, and a memory storing instructions. The communication interface is configured to be connected to a plurality of conference servers configured to execute a plurality of processes that controls respective ones of a plurality of teleconferences executed among a plurality of terminal apparatuses. When executed by the controller, the instructions cause the control apparatus to perform: determining, based on first information indicative of a processing load of each of the plurality of conference servers, whether there is a conference server having the processing load larger than or equal to a first threshold among the plurality of conference servers; in response to determining that there is a conference server having the processing load larger than or equal to the first threshold, determining, based on the first information and second information, possible combinations from a plurality of combinations of the plurality of processes that is allocated to the plurality of conference servers, the second information being indicative of the processing load of each of the plurality of processes, the possible combinations being the plurality of combinations in which the processing load of each of the plurality of conference servers is smaller than or equal to a second threshold; calculating evaluation information for evaluating the plurality of processes corresponding to each of the possible combinations, the evaluation information being calculated for each of the possible combinations based on at least one of the plurality of conference servers that executes the plurality of processes and the plurality of terminal apparatuses participating in the plurality of teleconferences controlled by the plurality of processes; determining, based on the evaluation information, one of the possible combinations as an execution combination that is a combination of the plurality of processes to be executed by each of the plurality of conference servers; and transmitting, through the communication interface, a notification to the plurality of conference servers such that the plurality of processes is executed by the execution combination, thereby allocating the plurality of processes to the plurality of conference servers.

### BRIEF DESCRIPTION OF THE DRAWINGS

Embodiments in accordance with this disclosure will be described in detail with reference to the following figures wherein:

FIG. 1 is a diagram illustrating an overview of a communication system 1;

FIG. 2 is a diagram illustrating an example of various tables 7;

FIG. 3 is a flowchart illustrating a first main processing;

FIG. 4 is a flowchart illustrating a table creation processing;

FIG. 5 is a flowchart illustrating a pattern determination processing;

FIG. 6 is a diagram illustrating an example of various tables 7;

FIG. 7 is a diagram illustrating an example of various tables 7;

FIG. 8 is a flowchart illustrating a second main processing;

FIG. 9 is a flowchart illustrating a table creation processing;

FIG. 10 is a diagram illustrating an example of various tables 7;

FIG. 11 is a diagram illustrating an example of various tables 7; and

FIG. 12 is a diagram illustrating an example of various tables 7.

### DETAILED DESCRIPTION

There is a case where a processing load is originally high in a conference server to which a new session with a terminal apparatus is connected due to the transfer control by the call control server. In this case, the processing load of the conference server further increases when the conference server communicates with the terminal apparatus. Therefore, a delay may occur in communication executed by the conference server and an error rate of the communication may increase. Thus, a teleconference may not be executed smoothly. When a conference server to which a new session is connected is selected by taking a processing load into consideration, for example, the conference server is preferably selected appropriately according to the conditions (the number of conferences, the number of connected terminals, and so on) of a conference held by the conference server.

An example of an object of this disclosure is to provide a storage medium storing a control program, a control method, and a control apparatus configured to appropriately select a conference server after transfer and transferring processes to the selected conference server so that a teleconference is executed continuously and smoothly.

<Overview of Communication System 1>

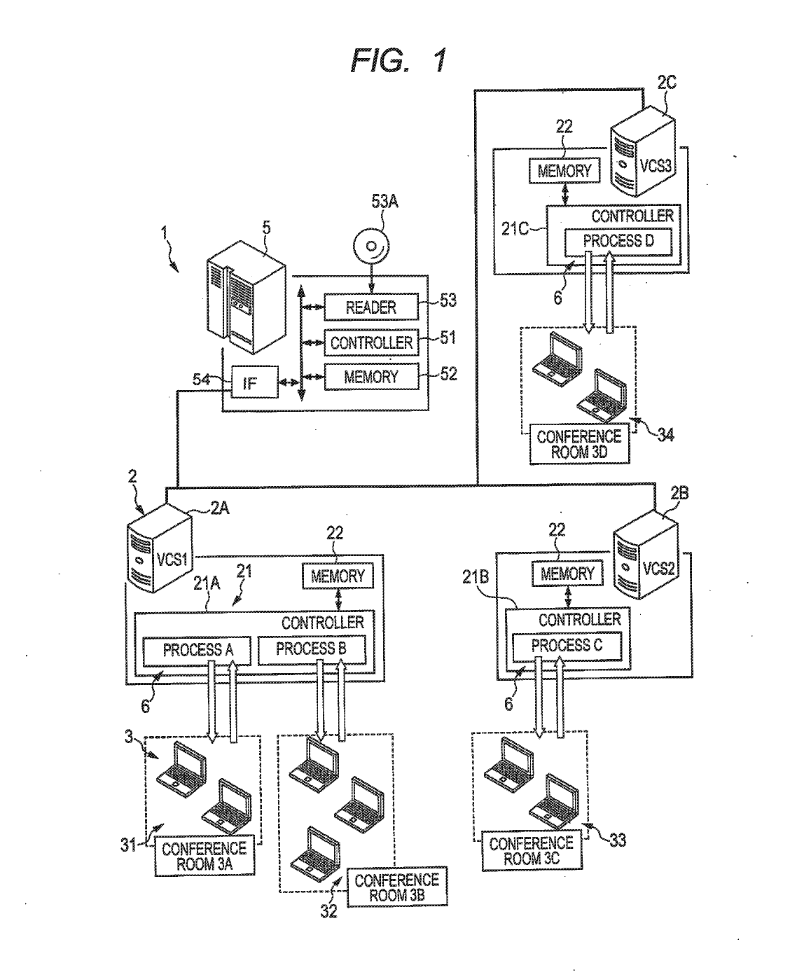

By referring to FIG. 1, a communication system 1 will be described. The communication system 1 includes conference servers 2A, 2B, and 2C (collectively referred to as a “conference server 2”), a plurality of terminal apparatuses 31 to 34 (collectively referred to as a “terminal apparatus 3”), and a control apparatus 5. The conference server 2, the terminal apparatus 3, and the control apparatus 5 are connected to each other via a network (LAN, Internet, and so on) (not shown).

The terminal apparatus 3 attends a virtual conference (simply referred to as a “conference”) to execute a teleconference by communicating with the conference server 2. The terminal apparatus 3 is formed by installing a teleconference application program on a known personal computer (PC). The conference server 2 executes a conference to allow the terminal apparatuses 3 to attend the conference so that a teleconference is executed between the terminal apparatuses 3. The conference server 2 is formed by installing a dedicated application program on a multi-point control unit (MCU) or a known server. The conference server 2 includes a controller 21 and a memory 22. The controller 21 is responsible for the entire control operation of the conference server 2. The controllers 21 of the conference servers 2A, 2B, and 2C are referred to as controllers 21A, 21B, and 21C, respectively. The memory 22 stores various programs executed by the controller 21. Hereinafter, an ID of the conference server 2 is referred to as “V-ID”. The V-IDs of the conference servers 2A, 2B, and 2C are referred to as “VCS1”, “VCS2”, and “VCS3”, respectively.

The control apparatus 5 performs communication with the conference servers 2A to 2C to control the allocation of processes (described later) executed by the conference servers 2A to 2C respectively. The control apparatus 5 is formed by installing a dedicated program on a known PC. The control apparatus 5 includes a controller 51, a memory 52, a reader 53, and a communication interface 54. The controller 51 is responsible for the entire control operation of the control apparatus 5. The memory 52 stores various programs executed by the controller 51 and various tables 7 described later. The reader 53 reads information stored in a storage medium 53A such as a semiconductor memory and an optical disc. The controller 51 reads programs stored in the storage medium 53A with the aid of the reader 53 and store the same in the memory 52. Programs may be downloaded from another server connected to a network (not shown) and be stored in the memory 52, for example. The communication interface 54 is configured to be connected to communication interfaces (not shown) of the conference servers 2A, 2B, and 2C through the network.

<Execution File (Process) Executed by Conference Server 2>

The controller 21 of the conference server 2 activates a process 6 in order to allow a teleconference to be executed between the terminal apparatuses 3. The process 6 indicates the units of execution of a program installed in the conference server 2. The process 6 is activated by execution of an execution file stored in the memory 22 and functions as a conference server that controls a teleconference. The process 6 holds a conference to allow the terminal apparatuses 3 to attend the conference and cause the terminal apparatuses 3 to execute a teleconference. When a plurality of conferences is held, processes 6 that hold the respective conferences are activated. That is, each process 6 holds one conference and executes a teleconference. Therefore, when a plurality of conferences is held, a plurality of processes 6 corresponding to the respective conferences is activated.

For example, in FIG. 1, processes A and B are executed by the controller 21A of the conference server 2A. The process A holds a conference 3A attended by a plurality of terminal apparatuses 31. The process B holds a conference 3B attended by a plurality of terminal apparatuses 32. In this manner, one controller 21 may execute a plurality of processes 6. A process C is executed by the controller 21B of the conference server 2B. The process C holds a conference 3C attended by a plurality of terminal apparatuses 33. A process D is executed by the controller 21C of the conference server 2C. The process D holds a conference 3D attended by a plurality of terminal apparatuses 34. Hereinafter, an ID of the process 6 will be referred to as a “P-ID”. The IDs of the processes A, B, C, and D will be referred to as “A”, “B”, “C”, and “D”, respectively.

<Table 7>

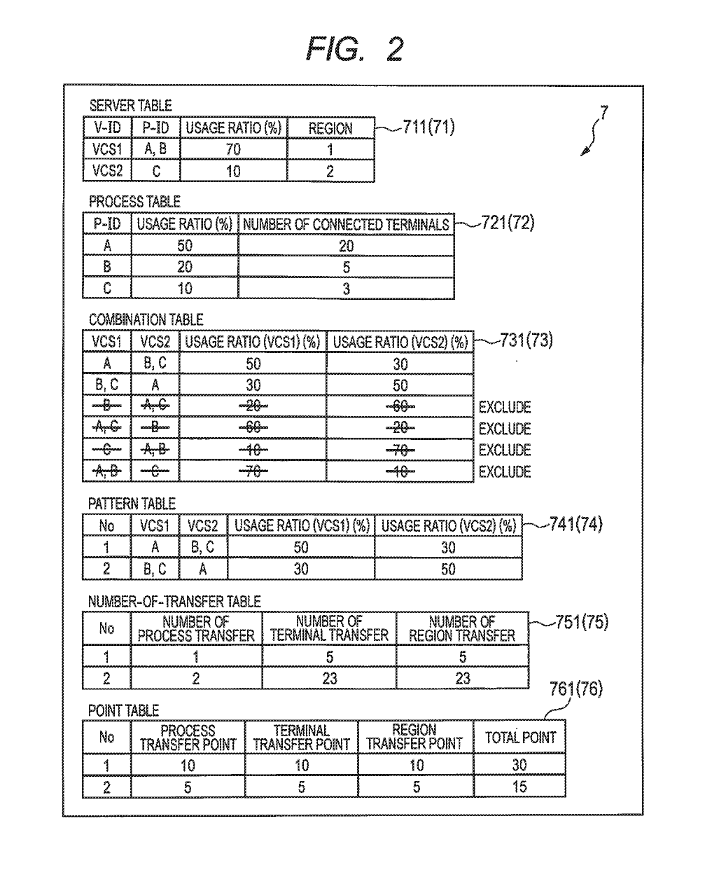

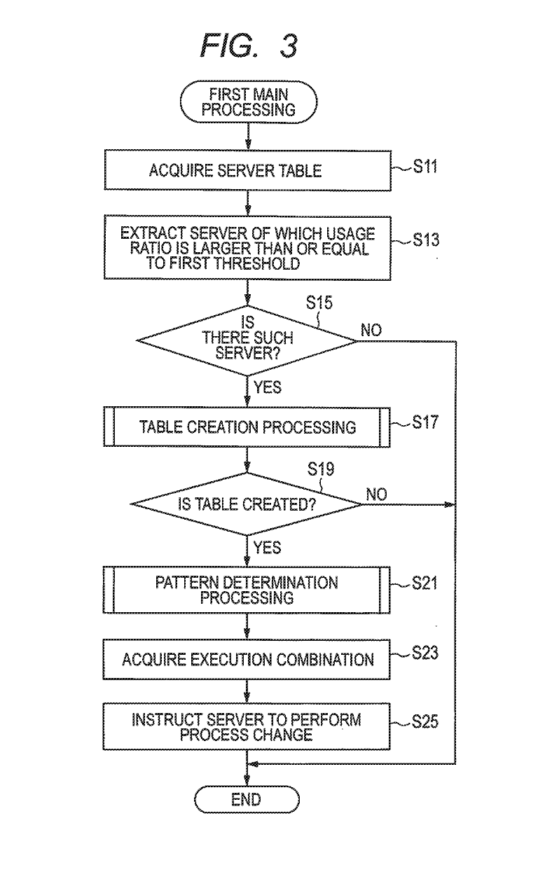

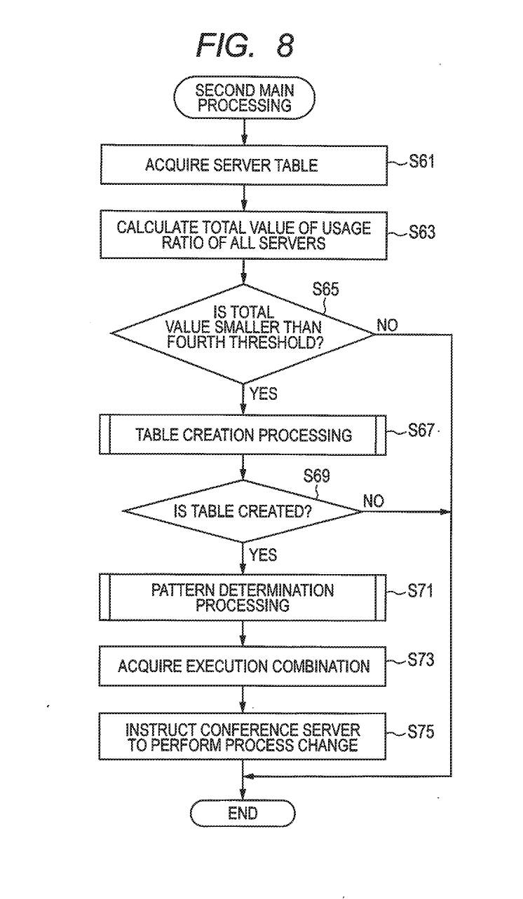

Examples of the tables 7 (a server table 71, a process table 72, a combination table 73, a pattern table 74, a number-of-transfer table 75, and a point table 76) stored in the memory 52 of the control apparatus 5 will be described with reference to FIG. 2. The server table 71 and the process table 72 are created by the controller 51 of the control apparatus 5 based on information acquired by the control apparatus 5 performing communication with the conference server 2 periodically. On the other hand, the combination table 73, the pattern table 74, the number-of-transfer table 75, and the point table 76 are created by the controller 51 executing a first main processing (see FIG. 3) and a second main processing (see FIG. 8) which are described later. The details of the combination table 73, the pattern table 74, the number-of-transfer table 75, and the point table 76 will be described later.

The server table 71 indicates the allocation of the processes 6 executed by the respective conference servers 2 at the present time and a processing load of the controller 51 when the conference server 2 executes the allocated processes 6. The V-ID of the conference server 2, the P-ID of the process 6, a usage ratio, and a region are stored in the server table 71 in association with one another. The P-ID indicates the process 6 executed by the controller 21 of the conference server 2 of the corresponding V-ID. The usage ratio is a usage ratio of the controller 21 of the conference server 2 of the corresponding V-ID (hereinafter referred to as a “usage ratio of the conference server 2”). A region where the conference server 2 is provided (that is, a parameter indicating a physical location of the conference server 2) is stored as the region. For example, in FIG. 2, the conference server 2A corresponding to the V-ID “VCS1” is provided in a region indicated by region “1” (for example, Japan), and the conference server 2B corresponding to the V-ID “VCS2” is provided in a region indicated by region “2” (for example, USA).

The process table 72 indicates a processing load when the conference server 2 executes the respective processes 6 at the present time. The P-ID of the process 6, the usage ratio, and the number of connected terminals are stored in the process table 72 in association with one another. The usage ratio is a usage ratio of the controller 21 when executing the process 6 having the corresponding P-ID (hereinafter referred to as a “usage ratio of the process 6”). The number of connected terminals indicates the number of terminal apparatuses 3 attending a conference executed by the process 6 having the corresponding P-ID.

The server table 711 and the process table 721 shown in FIG. 2 indicate a state in which the process D is not executed by the conference server 2C in FIG. 1.

### First Embodiment (Case where Processes are Executed Based on Various Tables in FIG. 2)

By referring to FIGS. 3 to 5, the first main processing executed by the controller 51 of the control apparatus 5 will be described. The first main processing starts repeatedly at particular periods when the controller 51 reads and executes a program stored in the memory 52. In the following description, the first main processing will be described in detail by assuming that the process D is not executed by the conference server 2C in FIG. 1, and the server table 711 and the process table 721 shown in FIG. 2 are stored in the memory 52.

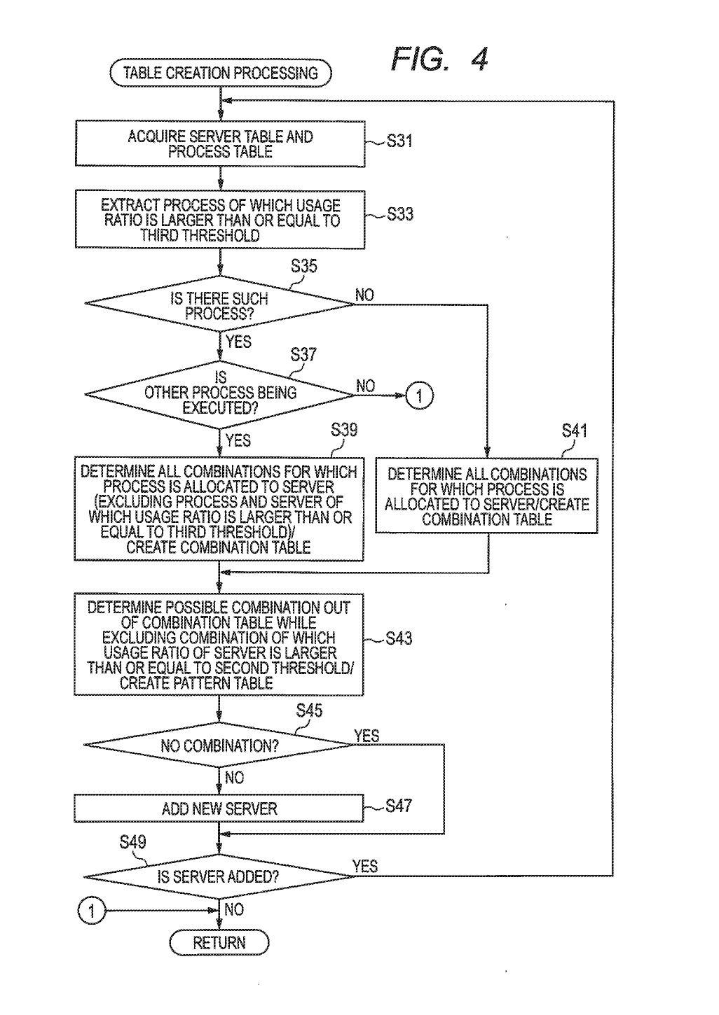

As shown in FIG. 3, the controller 51 acquires the server table 711 (see FIG. 2) stored in the memory 52 (S11). The controller 51 selects a usage ratio larger than or equal to a first threshold (for example, 70%) within the acquired server table 711 and extracts the conference server 2 having the V-ID associated with the selected usage ratio (S13). The controller 51 determines whether the controller succeeded in extracting the controller 2 (that is, whether the conference server 2 having the usage ratio larger than or equal to the first threshold exists) (S15). In FIG. 2, since the usage ratio associated with the V-ID “VCS1” in the server table 711 is 70% and is larger than or equal to the first threshold, the controller 51 determines that the conference server 2 having the usage ratio larger than or equal to the first threshold exists (S15: YES). In this case, the controller 51 executes a table creation processing (see FIG. 4) in order to create the combination table 731 and the pattern table 741 (see FIG. 2) (S17). On the other hand, when it is determined that the conference server 2 having the usage ratio larger than or equal to the first threshold does not exist (S15: NO), the controller 51 ends the first main processing.

A table creation processing will be described with reference to FIG. 4. The controller 51 acquires the server table 711 and the process table 721 (see FIG. 2) stored in the memory 52 (S31). The controller 51 selects a usage ratio larger than or equal to a third threshold within the acquired process table 721 and extracts the process 6 having the P-ID associated with the selected usage ratio (S33). The controller 51 determines whether the controller 51 succeeded in extracting the process 6 (that is, whether the process 6 having the usage ratio larger than or equal to the third threshold exists) (S35). In FIG. 2, since all the usage ratios in the process table 721 are smaller than 70% and are smaller than the third threshold, the controller 51 determines that the process 6 having the usage ratio larger than or equal to the third threshold does not exist (S35: NO). In this case, the controller 51 proceeds to S41.

The controller 51 acquires all V-IDs “VCS1” and “VCS2” stored in the server table 711 and determines the corresponding conference servers 2A and 2B. The controller 51 acquires all P-IDs “A”, “B”, and “C” stored in the process table 721 and determines the corresponding processes A, B, and C. The controller 51 determines all combinations of the conference servers 2 and the processes 6 in the case of allocating the processes A to C to the conference servers 2A and 2B (S41). The controller 51 creates the combination table 731 (see FIG. 2) including the determined combinations (S41). The controller 51 further calculates the usage ratios of the respective conference servers 2 when the respective processes 6 are executed based on the determined combinations and adds the calculated usage ratios to the combination table 731. The usage ratio of each conference server 2 is calculated by summing the usage ratios of the processes 6 included in each combination for each conference servers 2 to which the processes 6 are allocated. The usage ratios of the processes 6 are determined based on the process table 721. The controller 51 proceeds to S43.

A specific example will be described. In the following description, “(X/Y)” indicates that the process 6 having the P-ID “Y” is allocated to the conference server 2 having the V-ID “X”. In the combination table 731 of FIG. 2, the P-IDs “A”, “B”, and “C” of the processes A to C allocated to each of the conference servers 2A and 2B are stored in association with one of the V-IDs “VCS1” and “VCS2”. As a result, six combinations (“(VCS1/A)(VCS2/B,C)”, “(VCS1/B,C)(VCS2/A)”, “(VCS1/B)(VCS2/A,C)”, “(VCS1/A,C)(VCS2/B)”, “(VCS1/C)(VCS2/A,B)”, and “(VCS1/A,B)(VCS2/C)”) are stored in the combination table 731.

The usage ratio of each of the conference servers 2A and 2B is stored for the respective combinations in association with the V-IDs “VCS1” and “VCS2”. For example, in the case of the combination “(VCS1/A)(VCS2/B,C)”, the usage ratio 50% of the process A in the process table 721 (see FIG. 2) is determined and stored as the usage ratio of the conference server 2A (VCS1). Moreover, the total value 30% of the usage ratio 20% of the process B and the usage ratio 10% of the process C in the process table 721 (see FIG. 2) is calculated and stored as the usage ratio of the conference server 2B (VCS2).

As shown in FIG. 4, the controller 51 excludes a combination in which the usage ratio of the conference server 2 is larger than or equal to a second threshold from the combination table 731 (see FIG. 2) stored in the memory 52 in S41 (S43). The second threshold (for example, 60%) is smaller than the first threshold. As shown in FIG. 2, for the combinations “(VCS1/B)(VCS2/A,C)”, “(VCS1/A,C)(VCS2/B)”, “(VCS1/C)(VCS2/A,B)”, and “(VCS1/A,B)(VCS2/C)” among the six combinations, one of the corresponding usage ratios of the conference servers 2A and 2B is larger than or equal to the second threshold. Thus, the controller 51 excludes these combinations from the combination table 731. As shown in FIG. 3, the controller 51 extracts information including the combinations (“(VCS1/A)(VCS2/B,C)” and “(VCS1/B,C)(VCS2/A)” remaining after the exclusion from the combination table 731 (hereinafter referred to as “possible combinations”) and creates the pattern table 741 (see FIG. 2) (S43). The controller 51 stores the pattern table 741 in the memory 52.

The controller 51 determines whether all combinations of the combination table 731 have been excluded in S43 (that is, whether there is no remaining combination to be stored in the memory 52 as the pattern table 741) (S45). In the case of the combination table 731 of FIG. 2, since there is a remaining combination without being excluded, the controller 51 determines that not all combinations of the combination table 731 are excluded (S45: YES). Since a new conference server 2 is not added in S47 (S49: NO), the controller 51 ends the table creation processing and returns to the first main processing (see FIG. 3).

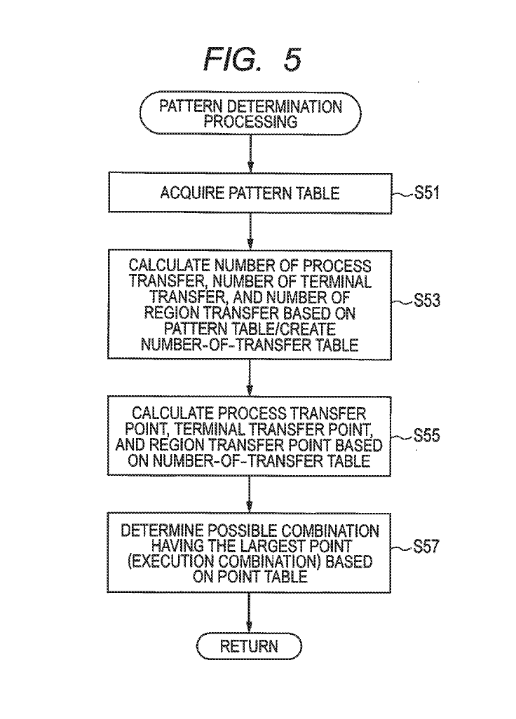

As shown in FIG. 3, after the table creation processing (see S17) ends, the controller 51 determines whether the pattern table 741 (see FIG. 2) is created by the table creation processing (S19). When the pattern table 741 is stored in the memory 52, the controller 51 determines that the pattern table 741 is created (S19: YES). In this case, the controller 51 executes a pattern determination processing (see FIG. 5) in order to finally determine the processes 6 to be allocated to the conference servers 2 based on the pattern table 741 (S21).

By referring to FIG. 5, the pattern determination processing will be described. The controller 51 acquires the pattern table 741 (see FIG. 2) stored in the memory 52 (S51). The controller 51 calculates, for each possible combination, the number of process transfer, the number of terminal transfer, and the number of region transfer based on the acquired pattern table 741 and on the server table 711 and the process table 721 (see FIG. 2) stored in the memory 52 (S53). The number of process transfer, the number of terminal transfer, and the number of region transfer indicate the number of processes 6 or terminal apparatuses 3 of which the state changes, assuming that the allocation of the processes 6 executed by each conference server 2 at the present time is changed to the allocation of the processes 6 indicated by each possible combination stored in the pattern table 741 (see FIG. 2). The allocation of the processes 6 executed by each conference servers 2 at the present time corresponds to the allocation of the processes 6 determined based on the server table 711 (see FIG. 2).

The number of process transfer indicates the number of processes 6 of which the executing conference server 2 is changed. For example, when the allocation “(VCS1/A,B)(VCS2/C)” of the processes 6 at the present time is changed to the possible combination “(VCS1/A)(VCS2/B,C)” of No. 1 of the pattern table 741 shown in FIG. 2, the executing server of the process B is changed from the conference server 2A (VCS1) to the conference server 2B (VCS2). Thus, the number of process transfer corresponding to the possible combination of No. 1 of the pattern table 741 is determined as “1”.

The number of terminal transfer indicates the number of terminal apparatuses 3 attending the conference held by the process 6 of which the executing conference server 2 is changed. For example, when the allocation “(VCS1/A,B)(VCS2/C)” of the process 6 at the present time is changed to the possible combination “(VCS1/A)(VCS2/B,C)” of No. 1 of the pattern table 741, the number of terminal apparatuses 3 attending the conference held by the process B of which the executing conference server 2 is changed is determined as “5” based on the process table 721 (see FIG. 2). Thus, the number of terminal transfer corresponding to the possible combination of No. 1 of the pattern table 741 is determined as “5”.

The number of region transfer indicates the number of terminal apparatuses 3 attending the conference held by the process 6 when the executing conference server 2 of the process 6 is changed to a conference server 2 in a different region. For example, when the allocation “(VCS1/A,B)(VCS2/C)” of the processes 6 at the present time is changed to the possible combination “(VCS1/A)(VCS2/B,C)” of No. 1 of the pattern table 741, the executing server of the process B is changed from the conference server 2A to the conference server 2B. In the server table 711, the region “1” associated with VCS1 is different from the region “2” associated with VCS2. The number of terminal apparatuses 3 attending the conference held by the process B is determined as “5” based on the process table 721 (see FIG. 2). Thus, the number of region transfer corresponding to the possible combination of No. 1 of the pattern table 741 is determined as “5”.

Although detailed description is omitted, the number of process transfer, the number of terminal transfer, and the number of region transfer are determined by a similar method when the allocation “(VCS1/A,B)(VCS2/C)” of the processes 6 at the present time is changed to the possible combination “(VCS1/B,C)(VCS2/A)” of No. 2 of the pattern table 741. Since the number of process transfer corresponding to the possible combination of No. 2 of the pattern table 741 is “2” (processes A and C), the number of terminal transfer and the number of region transfer are determined for each of the processes A and C of which the executing conference server 2 is changed and are added up.

As shown in FIG. 5, the controller 51 creates the number-of-transfer table 751 by associating the determined number of process transfer, number of terminal transfer, and number of region transfer with indices indicating the corresponding possible combinations (see FIG. 2) (S53). The controller 51 stores the created number-of-transfer table 751 in the memory 52.

The controller 51 calculates points corresponding to the number of process transfer, the number of terminal transfer, and the number of region transfer respectively (hereinafter collectively referred to as “number of transfer”) in the number-of-transfer table 751 stored in the memory 52 (S55). A point corresponding to the number of process transfer is referred to as a “process transfer point”. The point corresponding to the number of terminal transfer is referred to as a “terminal transfer point”. The point corresponding to the number of region transfer is referred to as a “region transfer point”. An expression for calculating the point is as follows. In this expression, “P” indicates a point, “X” indicates the number of transfer serving as a point calculation target, “Xmin” indicates a smallest value of the number of transfer, and “Xmax” indicates a largest value of the number of transfer.

P=(1/(Y+1))×10

(where Y=(X−Xmin)/(Xmax−Xmin))

This expression is an example only. Therefore, the point P may be calculated by using another expression other than the above-mentioned expression.

A case where the points are calculated based on the number-of-transfer table 751 in FIG. 2 will be described in detail. The number of process transfer of No. 1 of the number-of-transfer table 751 is “1”, the largest value of the number of process transfer is “2”, and the smallest value of the number of process transfer is “1”. Therefore, since Y is calculated as “(1-1)/(2-1)=0”, the process transfer point of the possible combination “(VCS1/A)(VCS2/B,C)” of No. 1 of the pattern table 741 is calculated as “(1/(0+1))×10=10”. On the other hand, the number of process transfer of No. 2 of the number-of-transfer table 751 is “2”. Therefore, since Y is calculated as “(2-1)/(2-1)=1”, the process transfer point of the possible combination “(VCS1/B,C)((VCS2/A)” of No. 2 of the pattern table 741 is calculated as “(1/(1+1))×10=5”.

The number of terminal transfer of the possible combination of No. 1 of the number-of-transfer table 751 is “5”, the largest value of the number of terminal transfer is “23”, and the smallest value of the number of terminal transfer is “5”. Therefore, since Y is calculated as “(5-5)/(23-5)=0”, the terminal transfer point of the possible combination “(VCS1/A)(VCS2/B,C)” of No. 1 of the pattern table 741 is calculated as “(1/(0+1))×10=10”. On the other hand, the number of terminal transfer of the possible combination of No. 2 of the number-of-transfer table 751 is “23”. Therefore, since Y is calculated as “(23-5)/(23-5)=1”, the terminal transfer point of the possible combination “(VCS1/B,C)(VCS2/A)” of No. 2 of the pattern table 741 is calculated as “(1/(1+1))×10=5”. In FIG. 2, the region transfer point is the same as the terminal transfer point.

The smaller the number of processes 6 of which the executing conference server 2 is changed, the larger becomes the process transfer point calculated in the above-described manner. The smaller the number of terminal apparatuses 3 attending the conference held by the process 6 of which the executing conference server 2 is changed, the larger becomes the terminal transfer point. The smaller the number of terminal apparatuses 3 attending the conference held by the process 6 of which the executing server is changed to a conference server 2 in another region, the larger becomes the region transfer point. That is, these pieces of information are used for evaluating each process 6 and are determined based on whether the executing conference server 2 of the process 6 is changed, the number of terminal apparatuses 3 attending the teleconference controlled by the process 6 of which the executing conference server 2 is changed, and the number of terminal apparatuses 3 attending the teleconference controlled by the process 6 of which the executing conference server 2 is changed to a conference server in another region.

As shown in FIG. 5, the controller 51 creates the point table 761 (see FIG. 2) by associating the process transfer point, the terminal transfer point, and the region transfer point calculated for each possible combination with one another (S55). The created point table 761 is used when determining one of the possible combinations (see S57). The controller 51 stores the created point table 761 in the memory 52.

The controller 51 adds up the points in the point table 761 (see FIG. 2) stored in the memory 52 for each of possible combinations (No. 1 or No. 2). In the case of the point table 761 in FIG. 2, the total value of the process transfer point, the terminal transfer point, and the region transfer point corresponding to the possible combination of No. 1 is “10+10+10=30”, and the total value of the process transfer point, the terminal transfer point, and the region transfer point corresponding to the possible combination of No. 2 is “5+5+5=15”. The controller 51 further stores the total value of the calculated points in the point table 761 in association with the corresponding possible combination. The controller 51 determines a possible combination in which the total value of the calculated points is the largest (here, the possible combination of No. 1) as the combination of the processes 6 to be executed by the conference server 2 (hereinafter referred to as an “execution combination”) (S57). The controller 51 ends the pattern determination processing and returns to the first main processing (see FIG. 3).

As shown in FIG. 3, after the pattern determination processing (see S21) ends, the controller 51 acquires the execution combination “(VCS1/A)(VCS2/B,C)” determined by the pattern determination processing (S23). The controller 51 acquires the allocation “(VCS1/A,B)(VCS2/C)” of the processes 6 executed by the conference servers 2 at the present time based on the server table 711 (see FIG. 2). The controller 51 acquires the process B of which the executing server is changed based on the respective allocations. The controller 51 further determines that, for the process B, the conference server 2A (V-ID: VCS1) is an executing server before change and the conference server 2B (V-ID: VCS2) is an executing server after change. The controller 51 transmits, to the conference server 2A through the communication interface 54, a notification instruction including the P-ID “B” of the process B of which the executing server is changed and the V-ID “VCS2” of the conference server 2B which is the executing server of the process B after change (S25). Upon receiving the notification instruction, the conference server 2A transmits a request instruction including the P-ID “B” of the process B to the conference server 2B having the V-ID “VCS2” included in the notification instruction. Upon receiving the request instruction, the conference server 2B starts execution of the process B having the P-ID “B” included in the request instruction. Further, the conference server 2A changes the connection destination of the terminal apparatuses 3 attending the conference held by the process B executed by itself, from the conference server 2A to the conference server 2B. In this way, the executing server of the process B is changed from the conference server 2A to the conference server 2B. The controller 51 ends the first main processing.

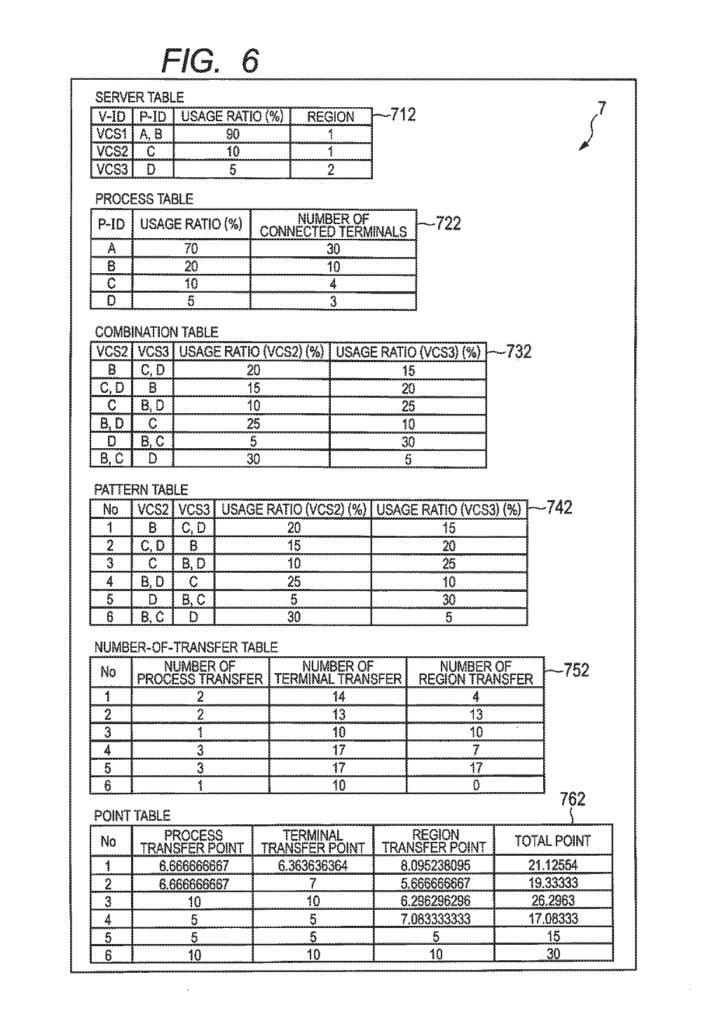

### First Embodiment (Case where Processes are Executed Based on Various Tables in FIG. 6)

The first main processing of FIGS. 3 to 5 will be described in detail by assuming that the processes A to D in the configuration shown in FIG. 1 are executed by the conference servers 2A to 2C, and the server table 712 and the process table 722 shown in FIG. 6 are stored in the memory 52. The description of portions overlapping the above-described content will be omitted or simplified.

As shown in FIG. 3, the controller 51 selects a usage ratio larger than or equal to the first threshold (for example, 70%) within the server table 712 (see FIG. 6) stored in the memory 52 and extracts the conference server 2 having the V-ID associated with the selected usage ratio (S13). In FIG. 6, the usage ratio associated with the V-ID “VCS1” in the server table 712 is 90% and is larger than or equal to the first threshold. Thus, the controller 51 determines that the conference server 2 having the usage ratio larger than or equal to the first threshold exists (S15: YES). The controller 51 executes the table creation processing (see FIG. 4) (S17). As shown in FIG. 4, the controller 51 selects a usage ratio larger than or equal to the third threshold within the process table 722 (see FIG. 6) stored in the memory 52 and extracts the process 6 having the P-ID associated with the selected usage ratio (S33). In FIG. 6, the usage ratio associated with the P-ID “A” in the process table 722 is 70% and is larger than or equal to the third threshold. Thus, the controller 51 determines that the process 6 having the usage ratio larger than or equal to the third threshold exists (S35: YES). In this case, the controller 51 proceeds to S37.

The controller 51 determines that the conference server 2A (V-ID: VCS1) executes the process A having the usage ratio larger than or equal to the first threshold based on the server table 712 (see FIG. 6). The controller 51 determines whether the determined conference server 2A is executing the process 6 other than the process A based on the server table 712 (S37). In the server table 712 shown in FIG. 6, “A” and “B” are stored as the P-ID corresponding to the V-ID “VCS1”. Thus, the controller 51 determines that the conference server 2A is executing the process B other than the process A (S37: YES). In this case, the controller 51 proceeds to S39.

The controller 51 acquires all V-IDs “VCS1”, “VCS2”, and “VCS3” stored in the server table 712 and determines the corresponding conference servers 2A, 2B, and 2C. The controller 51 acquires all P-IDs “A”, “B”, “C”, and “D” stored in the process table 722 and determines the corresponding processes A, B, C, and D. The controller 51 extracts, from the conference servers 2A to 2C, the conference servers 2B and 2C by excluding the conference server 2A that is executing the process A having the usage ratio larger than or equal to the third threshold. The controller 51 extracts, from the processes A to D, the processes B to D excluding the process A having the usage ratio larger than or equal to the third threshold. The controller 51 determines combinations when allocating the processes B to D to the conference servers 2B and 2C (S39). The controller 51 stores the determined combinations in the combination table 732 (see FIG. 6). The controller 51 calculates the usage ratio of each conference server 2 when the respective processes 6 are executed based on the determined combinations and stores the calculated usage ratios in the combination table 732. The controller 51 proceeds to S43.

The controller 51 excludes combinations in which the usage ratio of the conference server 2 is larger than or equal to the second threshold (for example, 60%) in the combination table 732 created in S39 from the combination table 732 (S43). As shown in FIG. 6, in the case of the combination table 732, all usage ratios of the conference servers 2B (V-ID: VCS2) and 2C (V-ID: VCS3) are smaller than the second threshold. Thus, the controller 51 does not exclude combinations from the combination table 732. The controller 51 extracts the information in the combination table 732 as the possible combination to create the pattern table 742 (see FIG. 6) (S43). The controller 51 stores the pattern table 742 in the memory 52. Since the combinations in the combination table 732 of FIG. 6 are not excluded (S45: YES) and a new conference server 2 is not added in S47 (S49: NO), the controller 51 ends the table creation processing and returns to the first main processing (see FIG. 3).

As shown in FIG. 3, since the pattern table 742 (see FIG. 6) is created by the table creation processing (see S17) (S19: YES), the controller 51 executes the pattern determination processing (see FIG. 5) (S21). As shown in FIG. 5, the controller 51 calculates, for each possible combination, the number of process transfer, the number of terminal transfer, and the number of region transfer based on the server table 712, the process table 722, and the pattern table 742 (see FIG. 6) stored in the memory 52 (S53). The controller 51 creates the number-of-transfer table 752 (see FIG. 6) by associating the determined number of process transfer, number of terminal transfer, and number of region transfer with indices indicating the corresponding possible combinations. The controller 51 calculates the process transfer point, the terminal transfer point, and the region transfer point based on the number-of-transfer table 752, and creates the point table 762 (see FIG. 6) by associating the calculated points with each possible combination (S55). The controller 51 adds up the points in the point table 762 (see FIG. 6) for each possible combination (No. 1 to No. 6). The controller 51 stores the calculated total value of the points in the point table 762 in association with the corresponding possible combination. The controller 51 determines a possible combination (the possible combination of No. 6) of which the calculated total value of points is the largest as the execution combination (S57). The controller 51 ends the pattern determination processing and returns to the first main processing (see FIG. 3).

As shown in FIG. 3, after the pattern determination processing (see S21) ends, the controller 51 acquires the execution combination (the possible combinations (VCS2/B,C)(VCS3/D) of No. 6 in the pattern table 742) determined by the pattern determination processing (S23). The controller 51 determines the allocations “(VCS1/A,B)(VCS2/C)(VCS3/D)” of the processes 6 executed by the respective conference servers 2 at the present time based on the server table 712 (see FIG. 2). The controller 51 determines the process B of which the executing server is changed based on the respective allocations. The controller 51 further determines that, for the process B, the conference server 2A (V-ID: VCS1) is an executing server before change and the conference server 2B (V-ID: VCS2) is an executing server after change. The controller 51 transmits, to the conference server 2A through the communication interface 54, a notification instruction including the P-ID “B” of the process B of which the executing server is changed and the V-ID “VCS2” of the conference server 2B which is the executing server of the process B after change (S25). Upon receiving the notification instruction, the conference server 2A transmits a request instruction including the P-ID “B” of the process B to the conference server 2B having the V-ID “VCS2” included in the notification instruction. Upon receiving the request instruction, the conference server 2B starts execution of the process B having the P-ID “B” included in the request instruction. Further, the conference server 2A changes the connection destination of the terminal apparatus 3 attending the conference held by the process B executed by itself, from the conference server 2A to the conference server 2B. In this way, the executing server of the process B is changed from the conference server 2A to the conference server 2B. The controller 51 ends the first main processing.

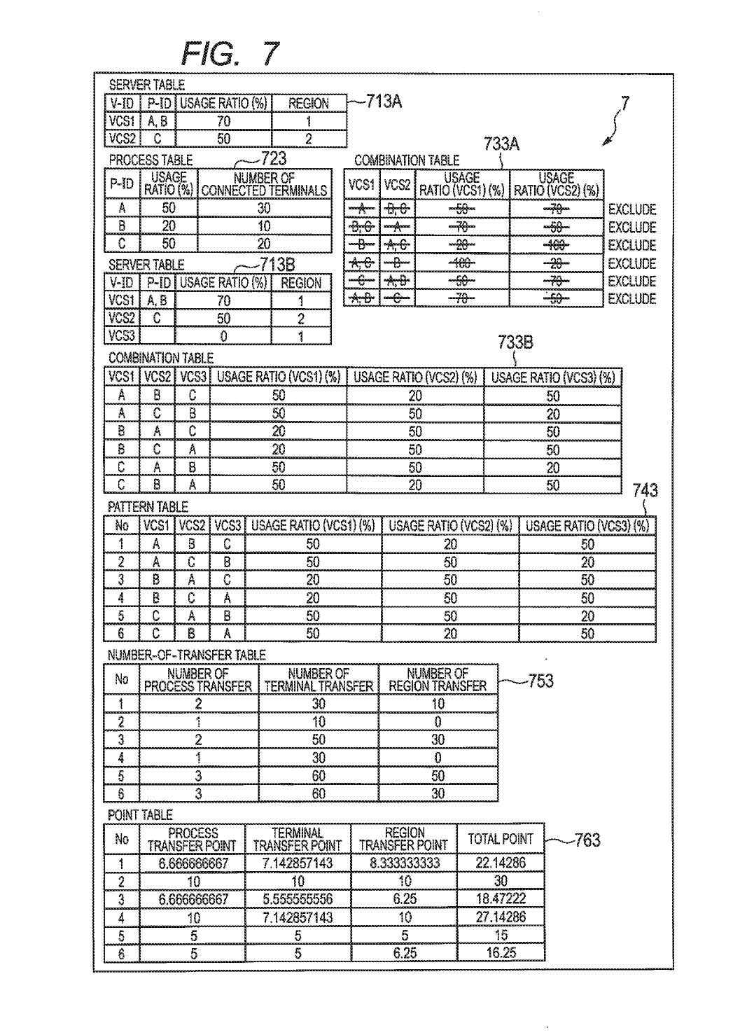

### First Embodiment (Case where Processes are Executed Based on Various Tables in FIG. 7)

The first main processing shown in FIGS. 3 to 5 will be described in detail by assuming that the process D is not executed by the conference server 2C in FIG. 1 and a server table 713A and a process table 723 shown in FIG. 7 are stored in the memory 52. The description of portions overlapping the above-described content will be omitted or simplified.

As shown in FIG. 3, the controller 51 selects a usage ratio larger than or equal to the first threshold (for example, 70%) within the server table 713A (see FIG. 7) stored in the memory 52 and extracts the conference server 2 having the V-ID associated with the selected usage ratio (S13). In FIG. 7, the usage ratio associated with the V-ID “VCS1” in the server table 713A is 70% and is larger than or equal to the first threshold. Thus, the controller 51 determines that the conference server 2 having the usage ratio larger than or equal to the first threshold exists (S15: YES). The controller 51 executes the table creation processing (see FIG. 4) (S17). As shown in FIG. 4, the controller 51 selects a usage ratio larger than or equal to the third threshold within the process table 723 (see FIG. 7) stored in the memory 52 and extracts the process 6 having the P-ID associated with the selected usage ratio (S33). In FIG. 7, all usage ratios stored in the process table 723 are smaller than 70% and smaller than the third threshold. Thus, the controller 51 determines that the process 6 having the usage ratio larger than or equal to the third threshold does not exist (S35: NO). In this case, the controller 51 proceeds to S41.

The controller 51 acquires all V-IDs “VCS1” and “VCS2” stored in the server table 713A (see FIG. 7) and determines the corresponding conference servers 2A and 2B. The controller 51 acquires all P-IDs “A”, “B”, and “C” stored in the process table 723 (see FIG. 7) and determines the corresponding processes A, B, and C. The controller 51 determines combinations in the case of allocating the processes A to C to the conference servers 2A and 2B (S41). The controller 51 creates a combination table 733A (see FIG. 7) including the determined combinations (S41). The controller 51 further calculates the usage ratios of the respective conference servers 2 when the respective processes 6 are executed based on the determined combinations, and stores the calculated usage ratios in the combination table 733A. The controller 51 proceeds to S43.

The controller 51 excludes combinations in which the usage ratio of the conference server 2 is larger than or equal to the second threshold (for example, 60%) from the combination table 733A (see FIG. 7) created in S41 (S43). As shown in FIG. 7, in the case of the combination table 733A, either one of the usage ratios of the corresponding conference servers 2A and 2B is larger than or equal to the second threshold for all combinations. Thus, the controller 51 excludes all combinations of the combination table 733. In this case, the controller 51 excludes all combinations in the combination table 733 and determines that no more combination is left (S45: NO). In this case, the controller 51 proceeds to S47.

The controller 51 adds a new conference server 2C (V-ID: VCS3) that is not executing the process 6 as a new candidate for the conference server 2 to which the processes A to C are allocated (S47). Specifically, the controller 51 outputs an activation command to the conference server 2C to activate the conference server function of the conference server 2C to create a state in which the process 6 is executable. The controller 51 adds the V-ID “VCS3” of the conference server 2C to the server table 713A (see FIG. 7) and creates a new server table 713B (see FIG. 7). The controller 51 stores a usage ratio of “0” in the server table 713B in association with the added V-ID “VCS3”, without storing the P-ID. The controller 51 further stores a region “1” indicating the same region as the conference server 2A, in the server table 713B in association with the added V-ID “VCS3”. As shown in FIG. 4, since the new conference server 2 is added in S47 (S49: YES), the controller 51 returns to S31. The controller 51 repeats the processing of S31 to S47 based on the created new server table 713B.

The controller 51 repeatedly executes S31 to S35 and proceeds to S41. The controller 51 acquires all V-IDs “VCS1”, “VCS2”, and “VCS3” stored in the server table 713B (see FIG. 7) and determines the corresponding conference servers 2A, 2B, and 2C. The controller 51 acquires all P-IDs “A”, “B”, and “C” stored in the process table 723 (see FIG. 7) and determines the corresponding processes A, B, and C. The controller 51 determines combinations in the case of allocating the processes A to C to the conference servers 2A to 2C (S41). The controller 51 creates a combination table 733B including the determined combinations (S41). The controller 51 further calculates the usage ratios of the respective conference servers 2 when the respective processes 6 are executed based on the determined combinations, and stores the calculated usage ratios in the combination table 733B.

The controller 51 excludes combinations in which the usage ratio of the conference server 2 is larger than or equal to the second threshold (for example, 60%) from the combination table 733B (see FIG. 7) stored in the memory 52 in S41 (S43). As shown in FIG. 7, in the case of the combination table 733B, the usage ratios of the corresponding conference servers 2A to 2C are smaller than the second threshold for all combinations. Thus, the controller 51 does not exclude combinations from the combination table 733. The controller 51 creates a pattern table 743 by extracting the information in the combination table 733B as the possible combinations (see FIG. 7) (S43). The controller 51 stores the pattern table 743 in the memory 52. Since the combinations in the combination table 733B shown in FIG. 7 are not excluded (S45: YES) and a new conference server 2 is not added in S47 (S49: NO), the controller 51 ends the table creation processing and returns to the first main processing (see FIG. 3).

As shown in FIG. 3, since the pattern table 743 (see FIG. 7) is created by the table creation processing (see S17) (S19: YES), the controller 51 executes the pattern determination processing (see FIG. 5) (S21). As shown in FIG. 5, the controller 51 calculates, for each possible combination, the number of process transfer, the number of terminal transfer, and the number of region transfer based on the server table 713B, the process table 723, and the pattern table 743 (see FIG. 7) stored in the memory 52 (S53). The controller 51 creates the number-of-transfer table 753 by associating the determined number of process transfer, number of terminal transfer, and number of region transfer with indices indicating the corresponding possible combinations (see FIG. 7). The controller 51 creates the point table 763 (see FIG. 7) by calculating the process transfer point, the terminal transfer point, and the region transfer point based on the number-of-transfer table 753 and associating the calculated points with each possible combination (S55). The controller 51 adds up the points in the point table 763 (see FIG. 7) for each possible combination (No. 1 to No. 6). The controller 51 further stores the calculated total value of the points in the point table 763 in association with the corresponding possible combination. The controller 51 determines a possible combination of which the calculated total value of points is the largest (the possible combination of No. 2) as the execution combination (S57). The controller 51 ends the pattern determination processing and returns to the first main processing (see FIG. 3).

As shown in FIG. 3, after the pattern determination processing (see S21) ends, the controller 51 acquires the execution combination determined by the pattern determination processing (the possible combinations (VCS1/A)(VCS2/C)(VCS3/B) of No. 2 in the pattern table 743) (S23). The controller 51 determines the allocations “(VCS1/A,B)(VCS2/C)(VCS3/None)” of the processes 6 executed by the respective conference servers 2 at the present time based on the server table 713B (see FIG. 7). The controller 51 determines the process B of which the executing server is changed based on the respective allocations. The controller 51 further determines that, for the process B, the conference server 2A (V-ID: VCS1) is an executing server before change and the conference server 2C (V-ID: VCS3) is an executing server after change. The controller 51 transmits, to the conference server 2A through the communication interface 54, a notification instruction including the P-ID “B” of the process B of which the executing server is changed and the V-ID “VCS3” of the conference server 2C which is the executing server of the process B after change (S25). Upon receiving the notification instruction, the conference server 2A transmits a request instruction including the P-ID “B” of the process B to the conference server 2C having the V-ID “VCS3” included in the notification instruction. Upon receiving the request instruction, the conference server 2C starts execution of the process B having the P-ID “B” included in the request instruction. Further, the conference server 2A changes the connection destination of the terminal apparatus 3 attending the conference held by the process B executed by itself, from the conference server 2A to the conference server 2C. In this way, the executing server of the process B is changed from the conference server 2A to the conference server 2C. The controller 51 ends the first main processing.

<Operation and Effects of First Embodiment>

The control apparatus 5 determines combinations of the processes 6 that are allocated to the conference server 2 (S39 and S41) when the conference server 2 having the usage ratio larger than or equal to the first threshold exists (S15: YES). The control apparatus 5 determines combinations in which the processing load of the conference server is smaller than the second threshold among the respective combinations as the possible combinations (S43). The control apparatus 5 determines, as an execution combination, a combination of the processes 6 to be executed by each of the plurality of conference servers 2 among the possible combinations based on the point table 76 (S57). The control apparatus 5 transmits a notification to the conference server 2 so that the processes 6 are executed by the determined execution combination (S25). The conference server 2 executes the processes 6 in response to the notification.

When the conference server 2 having the usage ratio larger than or equal to the first threshold exists, the control apparatus 5 determines an execution combination among combinations (possible combinations) in which the processing load of the conference server is smaller than the second threshold and change the executing server of the processes 6 to another conference server 2. Thus, the control apparatus 5 reduces the usage ratio of the conference servers 2 of which the usage ratio is larger than or equal to the first threshold. Moreover, since an increase in the processing load when the conference server 2 executes a new process 6 is suppressed, the control apparatus 5 executes a teleconference controlled by the process 6 smoothly. The control apparatus 5 further determines an execution combination by referring to the point table 76 including information for evaluating the process 6. In this way, the control apparatus 5 determines an execution combination according to the state of the process 6 and causes an appropriate conference server 2 to execute the process 6.

For example, the smaller the number of processes 6 of which the executing conference server 2 is changed, the larger becomes the process transfer point in the point table 76. Thus, when a possible combination having a larger process transfer point is determined as an execution combination, the number of processes 6 of which the executing conference server 2 is changed is decreased. Moreover, the smaller the number of terminal apparatuses 3 attending the conference held by the process 6 of which the executing conference server 2 is changed, the larger becomes the terminal transfer point of the point table 76. Thus, a possible combination having a larger terminal transfer point is determined as an execution combination, which reduces the number of terminal apparatuses 3 communicating with the conference server 2 that is changed due to the change of the executing server of the process 6. Further, the smaller the number of terminal apparatuses 3 attending the conference held by the process 6 of which the executing server is changed to a conference server 2 in another region, the larger becomes the region transfer point of the point table 76. Thus, a possible combination having a larger region transfer point is determined as an execution combination, which reduces the number of terminal apparatuses 3 communicating with the conference server 2 that is changed to a conference server 2 in another region due to the change of the executing server of the process 6.

When a process 6 of which the usage ratio is larger than or equal to the third threshold (referred to as a “load process”) exists (S35: YES), the control apparatus 5 determines, as possible combinations, a plurality of combinations in which the processes 6 other than the load process are allocated to the conference servers 2 other than the conference server 2 executing the load process (referred to as an “executing server”) (S39). That is, the control apparatus 5 causes the conference servers 2 other than the executing server to execute the processes 6 other than the load process among the processes 6 that are being executed by the executing server. In this way, the control apparatus 5 suppresses the influence on other processes 6 executed by the executing server, of the processing load of the load process. Therefore, the control apparatus 5 executes the teleconference executed by the other processes 6 smoothly.

The control apparatus 5 excludes combinations in which the usage ratio of the process 6 for each possible combination is larger than or equal to the second threshold (S43). In this way, the control apparatus 5 prevents an increase in the usage ratio of the conference server 2 when the executing conference server 2 of the process 6 is changed. Thus, the control apparatus 5 executes the teleconference controlled by the process 6 executed by the conference server 2 smoothly after the executing conference server 2 of the process 6 is changed. Moreover, the second threshold (for example, 60%) is set to be smaller than the first threshold (for example, 70%). Thus, the control apparatus 5 suppresses the usage ratio of the conference server 2 included in the combination which is not excluded in S43 from becoming larger than or equal to the first threshold immediately after the determination of S43. This prevents the determination processing of the possible combination from being executed frequently.

When all combinations in the combination table 73 are excluded (S45: NO), the control apparatus 5 adds a new conference server (S47). When a new conference server is added, the control apparatus 5 determines combinations of processes that are allocated to each of the conference servers 2 including the added new conference server again (S39 and S41). This reduces an increase in the usage ratio of the conference server 2 after the processes 6 executed by the respective conference servers 2 are changed, by causing the added new conference server 2 to execute the processes 6.

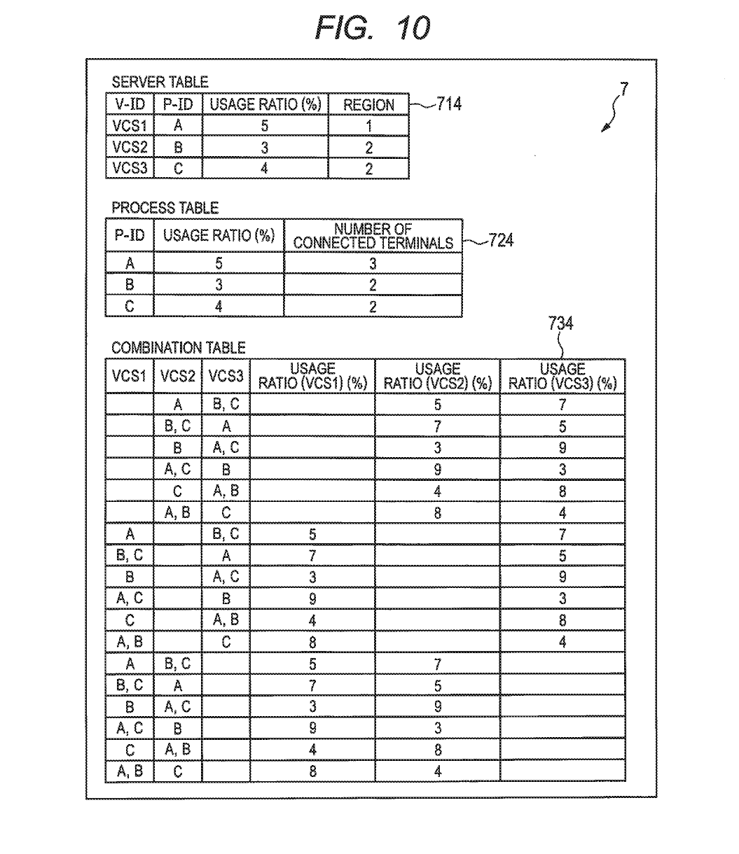

### Second Embodiment (Case where Processes are Executed Based on Various Tables in FIGS. 10 to 12)

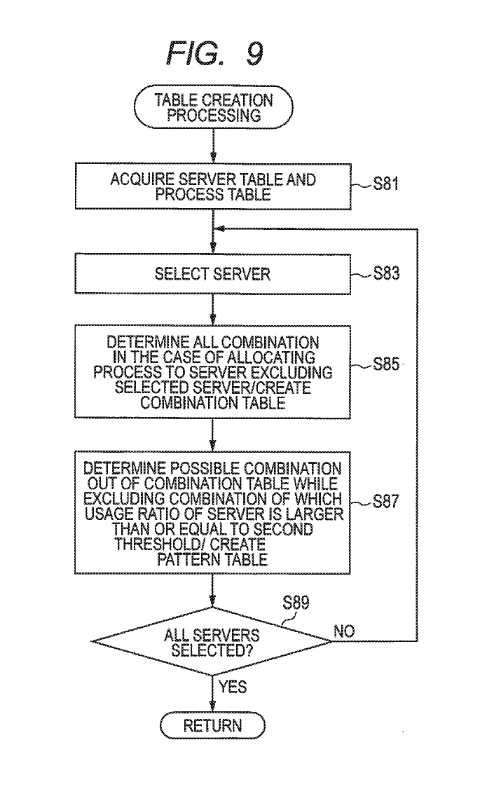

By referring to FIGS. 8 and 9, the second main processing executed by the controller 51 of the control apparatus 5 will be described. The second main processing starts repeatedly at particular periods when the controller 51 reads and executes a program stored in the memory 52. In the following description, the second main processing shown in FIGS. 8 and 9 will be described in detail by assuming that the process D in FIG. 1 is not executed, the processes A to C are executed by the conference servers 2A to 2C, and a server table 714 and a process table 724 shown in FIG. 10 are stored in the memory 52. The description of portions overlapping the content of the first main processing will be omitted or simplified.

As shown in FIG. 8, the controller 51 acquires the server table 714 (see FIG. 10) stored in the memory 52. The controller 51 calculates the total value of the usage ratios stored in the acquired server table 714 (that is, the total value of the usage ratios of all conference servers 2) (S63). The total value of the usage ratios calculated based on the server table 714 shown in FIG. 10 is “5(VCS1)+3(VCS2)+4(VCS3)=12” (%).

The controller 51 applies the number of V-IDs stored in the server table 714 (that is, the number of conference servers 2 executing the processes 6 in the communication system 1) to the following expression to calculate a fourth threshold (%). In this expression, “Th4” indicates the fourth threshold, and “n” indicates the number of conference servers 2.

Th4=n×5

This expression is an example only. Therefore, the fourth threshold may be calculated by using another expression other than the above-mentioned expression. Since the number of V-IDs stored in the server table 714 shown in FIG. 10 is 3 (VCS1, VCS2, and VCS3), the fourth threshold is calculated as “3×5=15” (%).

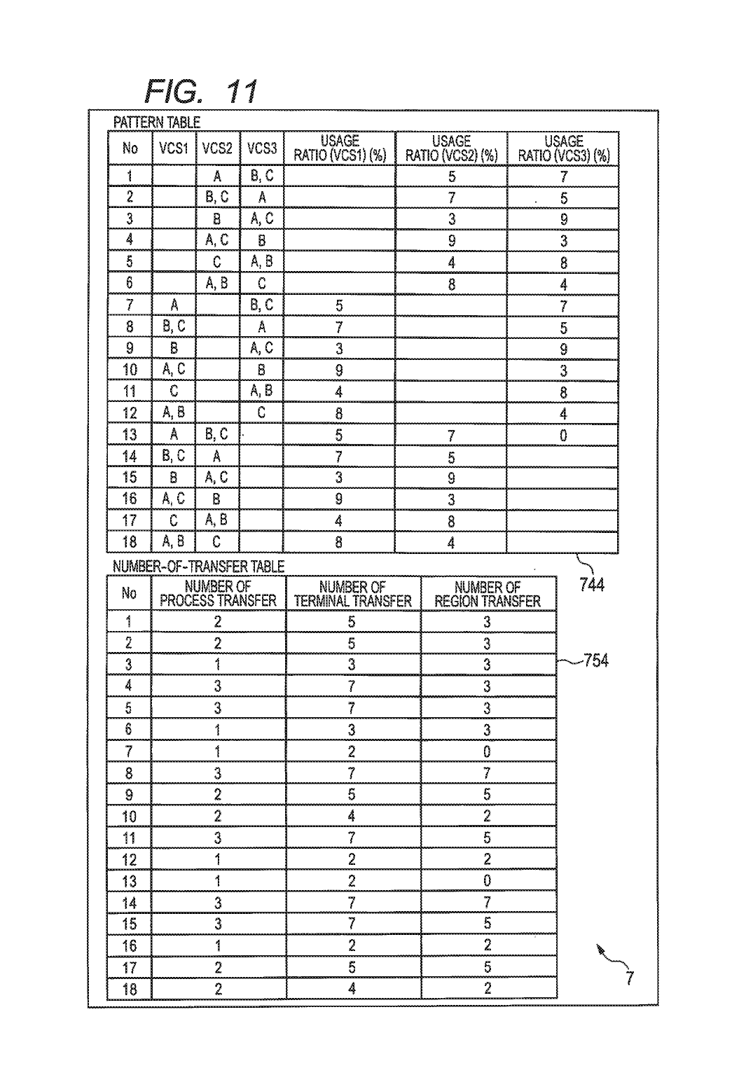

As shown in FIG. 8, the controller 51 determines that the total value “12%” calculated in S63 is smaller than the fourth threshold (15%) (S65: YES). In this case, the controller 51 executes a table creation processing (see FIG. 9) in order to create a combination table 734 (see FIG. 10) and a pattern table 744 (see FIG. 11) (S67). When it is determined that the total value is larger than or equal to the fourth threshold (S65: NO), the controller 51 ends the second main processing.

By referring to FIG. 9, the table creation processing will be described. The controller 51 acquires the server table 714 and the process table 724 (see FIG. 10) stored in the memory 52 (S81). The controller 51 acquires all V-IDs “VCS1”, “VCS2”, and “VCS3” stored in the server table 714 and determines the corresponding conference servers 2A, 2B, and 2C. The controller 51 acquires all P-IDs “A”, “B”, and “C” stored in the process table 724 and determines the corresponding processes A, B, and C. The controller 51 selects the conference server 2A among the acquired conference servers 2A to 2C (S83). The controller 51 determines all combinations of the conference servers 2 and the processes 6 in the case of allocating the processes A to C to the conference servers 2B and 2C excluding the selected conference server 2A among the conference servers 2A to 2C (S85). The controller 51 creates the combination table 734 (see FIG. 10) including the determined combinations (S85). The controller 51 further calculates the usage ratios of the respective conference servers 2 when the respective processes 6 are executed based on the determined combinations, and stores the calculated usage ratios in the combination table 734.

The controller 51 excludes combinations in which the usage ratio of the conference server 2 is larger than or equal to the second threshold (for example, 60%) from the combination table 734 (see FIG. 10) created in S85 (S87). The controller 51 creates the pattern table 744 (see FIG. 11) by extracting information including the combinations remaining after the exclusion from the combination table 734 as possible combinations (S87). The controller 51 stores the pattern table 744 in the memory 52.

A specific example will be described. First, the conference server 2A is selected in S83. Combinations “(VCS2/A)(VCS3/B,C)”, “(VCS2/B,C)(VCS3/A)”, “(VCS2/B)(VCS3/A,C)”, “(VCS2/A,C)(VCS3/B)”, “(VCS2/C)(VCS3/A,B)”, and “(VCS2/A,B)(VCS3/C)” are determined as combinations in the case of allocating the processes A to C to the conference servers 2B and 2C excluding the selected conference server 2A (S85). The combination table 734 (see FIG. 10) including the determined combinations is created (S85). Further, the usage ratios of the respective conference servers 2 when the respective processes 6 are executed based on the determined combinations are calculated and are stored in the combination table 734 (S85). As shown in FIG. 10, all usage ratios associated with the above combinations are smaller than the second threshold. Thus, no combination is excluded in S87. The controller 51 creates the pattern table 744 (see FIG. 11) by extracting the information in the combination table 734 as possible combinations as it is (S87).

As shown in FIG. 9, the controller 51 determines whether all conference servers 2A, 2B, and 2C determined based on the server table 714 are selected in S83 (S89). Since the conference server 2B and 2C are not selected (S89: NO), the controller 51 returns to S83. The controller 51 next selects the conference server 2B among the conference server 2B and 2C which are not selected (S83). The controller 51 repeats the processes of S85, S87, and S89 and returns to S83. The controller 51 selects the conference server 2C subsequently (S83) and repeats the processes of S85 and S87.

A specific example will be described. When the conference server 2B is selected in S83, combinations “(VCS1/A)(VCS3/B,C)”, “(VCS1/B,C)(VCS3/A)”, “(VCS1/B)(VCS3/A,C)”, “(VCS1/A,C)(VCS3/B)”, “(VCS1/C)(VCS3/A, B)”, and “(VCS1/A,B)(VCS3/C)” are determined as combinations in the case of allocating the processes A to C to the conference servers 2A and 2C excluding the conference server 2B (S85). Further, the determined combinations are added to and stored in the combination table 734 (see FIG. 10) (S85). The usage ratios of the respective conference servers 2 are calculated and are stored in the combination table 734 (S85). As shown in FIG. 10, all usage ratios associated with the above combinations are smaller than the second threshold. Thus, no combination is excluded in S87. The controller 51 creates the pattern table 744 (see FIG. 11) by extracting the information in the combination table 734 as possible combinations as it is (S87).

Subsequently, when the conference server 2C is selected in S83, combinations in the case of allocating the processes A to C to the conference servers 2A and 2B excluding the conference server 2C are determined (S85). The determined combinations are added to and stored in the combination table 734 (see FIG. 10). Further, the usage ratios of the respective conference servers 2 are calculated and are stored in the combination table 734 (S85). As shown in FIG. 10, all usage ratios associated with the combinations when the conference server 2C is excluded are smaller than the second threshold. Thus, no combination is excluded in S87. The controller 51 creates the pattern table 744 (see FIG. 11) by extracting the information in the combination table 734 as possible combinations as it is (S87).

As shown in FIG. 9, when it is determined that all conference servers 2A, 2B, and 2C determined based on the server table 714 are selected in S83 (S89: YES), the controller 51 ends the table creation processing and returns to the second main processing (see FIG. 8).

As shown in FIG. 8, after the table creation processing (see S67) ends, the controller 51 determines whether the pattern table 744 (see FIG. 11) is created by the table creation processing (S69). When it is determined that the pattern table 744 is created (S69: YES), the controller 51 executes the pattern determination processing (see FIG. 5) in order to finally determine the process 6 to be allocated to the conference server 2 based on the pattern table 744 (S71). The pattern determination processing is the same as the process executed in S21 (see FIG. 3) of the first main processing. On the other hand, when it is determined that the pattern table 744 is not created (S69: NO), the controller 51 ends the second main processing.

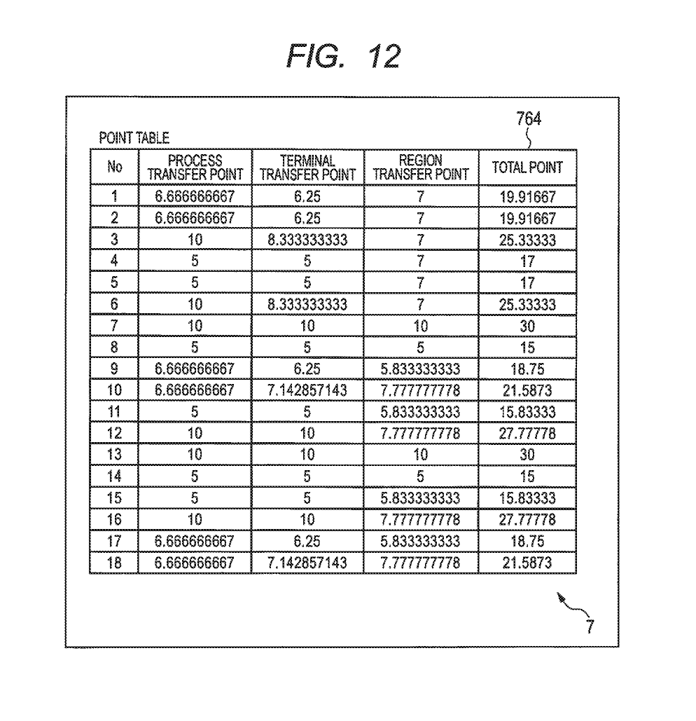

As shown in FIG. 5, the controller 51 calculates, for each possible combination, the number of process transfer, the number of terminal transfer, and the number of region transfer based on the pattern table 744 (see FIG. 11) and the server table 714 and the process table 724 (see FIG. 10) stored in the memory 52 (S53). The controller 51 creates the number-of-transfer table 754 (see FIG. 11) by associating the calculated number of process transfer, number of terminal transfer, and number of region transfer with indices indicating the corresponding possible combinations (S53). The controller 51 calculates the points corresponding to each of the number of process transfer, the number of terminal transfer, and the number of region transfer in the number-of-transfer table 754 (S55). The controller 51 creates the point table 764 (see FIG. 12) by associating the process transfer point, the terminal transfer point, and the region transfer point calculated for each possible combination (S55). The controller 51 adds up the points in the point table 764 (see FIG. 11) for each possible combination (No. 1 to No. 18). The controller 51 further stores the total value of the calculated points in the point table 764 in association with the corresponding possible combination. The controller 51 determines a possible combination in which the total value of calculated points is the largest as an execution combination (S57).

In the case of the point table 764 shown in FIG. 12, two possible combinations of Nos. 7 and 13 correspond to the possible combination in which the total value of points is the largest. In such a case, the controller 51 determines one possible combination determined based on particular rules (for example, the possible combination of No. 7 having the smallest index) as an execution combination (S57). The controller 51 ends the pattern determination processing and returns to the second main processing (see FIG. 3).

As shown in FIG. 8, after the pattern determination processing (see S71) ends, the controller 51 acquires the execution combination determined by the pattern determination processing (the possible combination “(VCS1/A)(VCS3/B,C)” of No. 7 in the pattern table 744) (S73). The controller 51 determines the allocations “(VCS1/A)(VCS2/B)(VCS3/C)” of the processes 6 executed by the respective conference servers 2 at the present time based on the server table 714 (see FIG. 10). The controller 51 determines the process B of which the executing server is changed, based on the respective allocations. The controller 51 further determines that, for the process B, the conference server 2B (V-ID: VCS2) is an executing server before change and the conference server 2C (V-ID: VCS3) is an executing server after change. The controller 51 transmits, to the conference server 2B, a notification instruction including the P-ID “B” of the process B of which the executing server is changed and the V-ID “VCS3” of the conference server 2C which is the executing server of the process B after change (S75). Upon receiving the notification instruction, the conference server 2B transmits a request instruction including the P-ID “B” of the process B to the conference server 2C having the V-ID “VCS3” included in the notification instruction. Upon receiving the request instruction, the conference server 2C starts execution of the process B having the P-ID “B” included in the request instruction. Further, the conference server 2B changes the connection destination of the terminal apparatus 3 attending the conference held by the process B executed by itself, from the conference server 2B to the conference server 2C. In this way, the executing server of the process B is changed from the conference server 2B to the conference server 2C. The controller 51 ends the second main processing.

<Operation and Effects of Second Embodiment>

When the total value of usage ratios of the conference servers 2 stored in the server table 714 is smaller than the fourth threshold (S65: YES), the control apparatus 5 determines the possible combinations by excluding conference servers 2 one at a time (S83, S85, and S87). The control apparatus 5 determines an execution combination from the determined possible combinations (S57) and causes the respective conference servers 2 to execute the processes 6 according to the execution combination (S75). In this case, the control apparatus 5 allocates the processes 6 to the conference servers 2 to execute the processes 6 with a minimum requisite configuration in which an unnecessary conference server 2 is excluded. Moreover, the control apparatus 5 excludes the conference server 2 when the total value of usage ratios is smaller than the fourth threshold, and determines possible combinations. In this way, the control apparatus 5 suppresses the processing of determining possible combinations and execution combinations from being executed frequently. Therefore, the control apparatus 5 prevents the conference servers 2 executing the processes 6 from being changed frequently.

<Modifications>

While the disclosure has been described in detail with reference to the above aspects thereof, it would be apparent to those skilled in the art that various changes and modifications may be made therein without departing from the scope of the claims.

For example, the processes executed by the controller 51 of the control apparatus 5 may be executed by the controller 21 of any one of the conference servers 2. In this case, the program stored in the memory 52 of the control apparatus 5 may be stored in the memory 22 of any one of the conference servers 2 in the above description. The controller 21 of the conference server 2 may execute the above processes by executing this program.

The usage ratios of the conference servers 2 or the processes 6 are stored in the server table 71, the process table 72, the combination table 73, and the pattern table 74. In contrast, other parameters indicating the processing load of the controller 21 of the conference server 2 may be stored instead of the usage ratio. For example, the usage ratio of a memory accessed when processes are executed by the controller 21 may be stored as the other parameters. Alternatively, a traffic volume of a network, a delay time, and an error rate may be stored as the other parameters instead of the usage ratio. The controller 51 may refer to the above parameters instead of the usage ratio when the first main processing or the second main processing is executed.

The controller 51 determines all combinations of the conference servers 2 and the processes 6 in the case of allocating the processes 6 to the conference servers 2 (S39 and S41). In contrast, the controller 51 may determine some (for example, a particular number of combinations) of all combinations. In this way, the controller 51 reduces the processing load required for determining an execution combination from possible combinations.

The controller 51 may determine the execution combination based on the total value point of any two of the process transfer point, the terminal transfer point, and the region transfer point in the point table 76. Moreover, the controller 51 may determine the execution combination based on any one of the process transfer point, the terminal transfer point, and the region transfer point in the point table 76. The controller 51 may determine the execution combination based on evaluation information different from the point table 76. For example, the controller 51 may store the process 6 having the largest usage ratio (referred to as a “largest process”) and the process 6 having the smallest usage ratio (referred to as a “smallest process”) in the memory 52 as evaluation information. The controller 51 may determine, as the execution combination, a combination in which the conference server 2 now executing the largest process stops executing the largest process and the conference server 2 now executing the smallest process executes the largest process.

The controller 51 determines in S15 whether the conference server 2 having the usage ratio larger than or equal to the first threshold exists. Moreover, the controller 51 determines in S35 whether the process 6 having the usage ratio larger than or equal to the third threshold exists. In the above-described example, the third threshold is the same as the first threshold. In contrast, the third threshold used for the controller 51 to extract the processes 6 in S33 may have a different value from the first threshold used for extracting the conference server 2 in S13. The third threshold may be larger or smaller than the first threshold. The respective thresholds are examples only, and the respective values are not limited to the values used in the above embodiments. For example, the first, second, and third thresholds may be the same and all or some of the thresholds may be different. The magnitude relationship between the first, second, and third thresholds is not limited to the above embodiments. For example, the second threshold may be larger than the first threshold.

In S47 the controller 51 may add two or more new conference servers 2 to which the processes 6 are allocated. When adding a new conference server 2, the controller 51 may determine the conference servers 2 to be added, by asking a management server (not shown) connected to a network. The conference server 2 provided in the same region as the conference server 2 executing the process 6 may be preferentially selected as the conference server 2 to be added. This is preferable since an increase in the number of region transfer in the point table 76 is suppressed.

In the second main processing, when the total value of usage ratios of the conference servers 2 stored in the server table 714 is smaller than the fourth threshold (25%) (S65: YES), the controller 51 executes the table creation processing to create the combination table 73 and the pattern table 74 to determine the possible combinations (S67). In contrast, the controller 51 may always execute the table creation processing regardless of the total value of usage ratios to determine the possible combinations. In this case, the control apparatus 5 determines the possible combinations with a minimal configuration excluding the unnecessary conference server 2, and allocates the processes 6 to the conference servers 2 to execute the processes 6, regardless of the usage ratios of the conference servers 2 at the present time.

In the second main processing, when executing the processing of S85, the controller 51 may determine the possible combinations with a configuration excluding two or more conference servers 2 and allocate the processes 6. When there is still a margin in the usage ratio of the conference server 2 after the possible combinations have been determined with a configuration excluding one conference server 2, the controller 51 may determine the possible combinations with a configuration excluding another conference server 2.

What is claimed is:

1. A non-transitory computer-readable storage medium storing a control program executable on a computer of a control apparatus configured to perform communication with a plurality of conference servers configured to execute a plurality of processes that controls respective ones of a plurality of teleconferences executed among a plurality of terminal apparatuses, the control program causing, when executed, the control apparatus to perform operations comprising:
determining, based on first information indicative of a processing load of each of the plurality of conference servers, whether there is a conference server having the processing load larger than or equal to a first threshold among the plurality of conference servers;
in response to determining that there is a conference server having the processing load larger than or equal to the first threshold, determining, based on the first information and second information, possible combinations from a plurality of combinations of the plurality of processes that is allocated to the plurality of conference servers, the second information being indicative of the processing load of each of the plurality of processes, the possible combinations being the plurality of combinations in which the processing load of each of the plurality of conference servers is smaller than or equal to a second threshold;
calculating evaluation information for evaluating the plurality of processes corresponding to each of the possible combinations, the evaluation information being calculated for each of the possible combinations based on at least one of the plurality of conference servers that executes the plurality of processes and the plurality of terminal apparatuses participating in the plurality of teleconferences controlled by the plurality of processes;
determining, based on the evaluation information, one of the possible combinations as an execution combination that is a combination of the plurality of processes to be executed by each of the plurality of conference servers; and
transmitting a notification to the plurality of conference servers such that the plurality of processes is executed by the execution combination, thereby allocating the plurality of processes to the plurality of conference servers.

2. The non-transitory computer-readable storage medium according to claim 1, wherein the control program further causes, when executed, the control apparatus to perform operations further comprising:
determining, based on the second information, whether there is a process having a processing load larger than or equal to a third threshold; and
determining whether an executing server is currently executing another process, the executing server being the conference server that is currently executing a load process determined to have the processing load larger than or equal to the third threshold; and
wherein the determining possible combinations comprises, in response to determining that the executing server is currently executing another process, determining the possible combinations from among a plurality of combinations in which the plurality of processes other than the load process is allocated to the plurality of conference servers other than the executing server.

3. The non-transitory computer-readable storage medium according to claim 1, wherein the determining possible combinations comprises excluding, from the plurality of combinations, a combination in which the processing load of at least one conference server is larger than or equal to the second threshold;
wherein the control program further causes, when executed, the control apparatus to perform operations further comprising adding a new conference server in a case where all of the plurality of combinations are excluded; and
wherein the determining possible combinations comprises, in a case where the new conference server is added, again determining the possible combinations from a plurality of combinations in which the plurality of processes is allocated to the plurality of conference servers including the new conference server.

4. The non-transitory computer-readable storage medium according to claim 2, wherein the determining possible combinations comprises, in response to determining that there is no process having the processing load larger than or equal to the third threshold, determining the possible combinations from among a plurality of combinations in which the plurality of processes is allocated to the plurality of conference servers without excluding a process or a conference server.

5. The non-transitory computer-readable storage medium according to claim 1, wherein the evaluation information is calculated based on at least one of a number of processes transferred to a different conference server and a number of terminal apparatuses transferred to a different conference server in each of the possible combinations.

6. The non-transitory computer-readable storage medium according to claim 5, wherein the evaluation information is calculated to a higher point as the number of processes transferred to a different conference server is smaller and as the number of terminal apparatuses transferred to a different conference server is smaller.

7. The non-transitory computer-readable storage medium according to claim 1, wherein the determining possible combinations comprises determining the possible combinations from among a plurality of combinations in which the plurality of processes is allocated to the plurality of conference servers from which at least one conference server is excluded.

8. The non-transitory computer-readable storage medium according to claim 7, wherein the control program further causes, when executed, the control apparatus to perform operations further comprising:
determining, based on the first information, whether a total value of the processing load of each of the plurality of conference servers is smaller than a fourth threshold without determining whether there is a conference server having the processing load larger than or equal to the first threshold; and
wherein the determining possible combinations comprises, in response to determining that the total value is smaller than the fourth threshold, determining the possible combinations from among the plurality of combinations in which the plurality of processes is allocated to the plurality of conference servers from which the at least one conference server is excluded.

9. A control method of performing communication with a plurality of conference servers configured to execute a plurality of processes that controls respective ones of a plurality of teleconferences executed among a plurality of terminal apparatuses, the control method comprising:
determining, based on first information indicative of a processing load of each of the plurality of conference servers, whether there is a conference server having the processing load larger than or equal to a first threshold among the plurality of conference servers;
in response to determining that there is a conference server having the processing load larger than or equal to the first threshold, determining, based on the first information and second information, possible combinations from a plurality of combinations of the plurality of processes that is allocated to the plurality of conference servers, the second information being indicative of the processing load of each of the plurality of processes, the possible combinations being the plurality of combinations in which the processing load of each of the plurality of conference servers is smaller than or equal to a second threshold;
calculating evaluation information for evaluating the plurality of processes corresponding to each of the possible combinations, the evaluation information being calculated for each of the possible combinations based on at least one of the plurality of conference servers that executes the plurality of processes and the plurality of terminal apparatuses participating in the plurality of teleconferences controlled by the plurality of processes;
determining, based on the evaluation information, one of the possible combinations as an execution combination that is a combination of the plurality of processes to be executed by each of the plurality of conference servers; and
transmitting a notification to the plurality of conference servers such that the plurality of processes is executed by the execution combination, thereby allocating the plurality of processes to the plurality of conference servers.

10. A control apparatus comprising:
a communication interface configured to be connected to a plurality of conference servers configured to execute a plurality of processes that controls respective ones of a plurality of teleconferences executed among a plurality of terminal apparatuses;
a controller; and
a memory storing instructions, the instruction, when executed by the controller, causing the control apparatus to perform:
determining, based on first information indicative of a processing load of each of the plurality of conference servers, whether there is a conference server having the processing load larger than or equal to a first threshold among the plurality of conference servers;
in response to determining that there is a conference server having the processing load larger than or equal to the first threshold, determining, based on the first information and second information, possible combinations from a plurality of combinations of the plurality of processes that is allocated to the plurality of conference servers, the second information being indicative of the processing load of each of the plurality of processes, the possible combinations being the plurality of combinations in which the processing load of each of the plurality of conference servers is smaller than or equal to a second threshold;
calculating evaluation information for evaluating the plurality of processes corresponding to each of the possible combinations, the evaluation information being calculated for each of the possible combinations based on at least one of the plurality of conference servers that executes the plurality of processes and the plurality of terminal apparatuses participating in the plurality of teleconferences controlled by the plurality of processes;
determining, based on the evaluation information, one of the possible combinations as an execution combination that is a combination of the plurality of processes to be executed by each of the plurality of conference servers; and
transmitting, through the communication interface, a notification to the plurality of conference servers such that the plurality of processes is executed by the execution combination, thereby allocating the plurality of processes to the plurality of conference servers.
